(19) United States
(12) Patent Application Publication
(10) Pub. No.: US 2006/0093736 A1
(43) Pub. Date: May 4, 2006

(54) Aluminum articles with wear-resistant coatings and methods for applying the coatings onto the articles

(76) Inventors: Derek Raybould, Denville, NJ (US); Murali N. Madhava, Gilbert, AZ (US); Vincent Chung, Tempe, AZ (US); Timothy R. Duffy, Chandler, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/976,749

(22) Filed: Oct. 29, 2004

(51) Int. Cl. B05D 1/12

(52) U.S. Cl. 427/180

(57) ABSTRACT

A method for coating a surface of a component formed from aluminum or an alloy thereof includes the step of cold gas-dynamic spraying a powder material on the component surface to form a coating, the powder material comprising at least one alloy from the group consisting of titanium, a titanium alloy, nickel, a nickel alloy, iron, an iron alloy, aluminum, an aluminum alloy, copper, a copper alloy, cobalt, and a cobalt alloy. In one embodiment, the method further includes the step of heat treating the turbine component after the cold gas-dynamic spraying.

### TECHNICAL FIELD

The present invention relates to aerospace engine and vehicle components that are manufactured from aluminum and aluminum alloys. More particularly, the present invention relates to methods for protecting the aluminum and aluminum alloy substrates with wear-resistant coatings to prevent erosion due to wear, corrosion, oxidation, and other hazards.

### BACKGROUND

Aluminum and many aluminum alloys typically have high strength:density ratios and stiffness:density ratios, are easily formable by conventional casting and forging processes, and are available at a relatively low cost. These properties make aluminum and aluminum alloys well suited as base materials for aerospace engine and vehicle components. Yet, aluminum has a low melting point of about 660° C. that limits its use to low temperature applications such as the “cold” section of engines. Further, aluminum-containing alloys are not suitable for many low temperature applications since the alloys typically have relatively poor wear and erosion resistance.

Some improvements for certain aluminum alloys have been directed to improved wear and erosion resistance. For instance, cast aluminum-silicon alloys have sufficient wear resistance to be used to form automotive pistons. However, the aluminum-silicon alloys have low ductility and toughness, making them less than ideal for aerospace applications. Also, wear resistant coatings can be applied to aluminum alloys by anodizing procedures and other methods, but such coatings can be scratched off with relative ease and significantly reduce fatigue life.

Hence, there is a need for methods and materials for coating aluminum and aluminum alloy components such as aerospace engine and vehicle components. There is a particular need for wear-resistant and erosion-resistant coating materials that will improve the components' durability without reducing the components' toughness and fatigue life, and for efficient and cost effective methods of coating the components with such materials.

### BRIEF SUMMARY

The present invention includes a method for coating a surface of a component formed from aluminum or an alloy thereof. The method comprises the step of cold gas-dynamic spraying a powder material on the component surface to form a coating, the powder material comprising at least one alloy from the group consisting of titanium, a titanium alloy, nickel, a nickel alloy, iron, an iron alloy, aluminum, an aluminum alloy, copper, a copper alloy, cobalt, and a cobalt alloy. In one embodiment, the method further comprises the step of heat treating the turbine component after the cold gas-dynamic spraying.

Other independent features and advantages of the preferred methods will become apparent from the following detailed description, taken in conjunction with the accompanying drawings which illustrate, by way of example, the principles of the invention.

### BRIEF DESCRIPTION OF THE DRAWINGS

FIG. 1 is a schematic view of an exemplary cold gas-dynamic spray apparatus in accordance with an exemplary embodiment; and

FIG. 2 is a flow diagram of a coating method in accordance with an exemplary embodiment.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention provides an improved method for coating components made from aluminum and aluminum alloys to prevent erosion due to corrosion, oxidation, wear, and other hazards. The method utilizes a cold gas-dynamic spray technique to coat component surfaces with alloys of suitable metals including titanium, titanium alloys, iron, iron alloys, nickel, nickel alloys, aluminum, aluminum alloys, copper, copper alloys, cobalt, and cobalt alloys. A heat treatment may follow the cold gas-dynamic spray technique to homogenize the coating microstructure, and also to improve bond strength, environment-resistance, and wear-resistance. These coatings can be used to improve the durability of aluminum or aluminum alloy aerospace engine or vehicle components such as air starters, impeller wheels, and valve bodies, to name several examples.

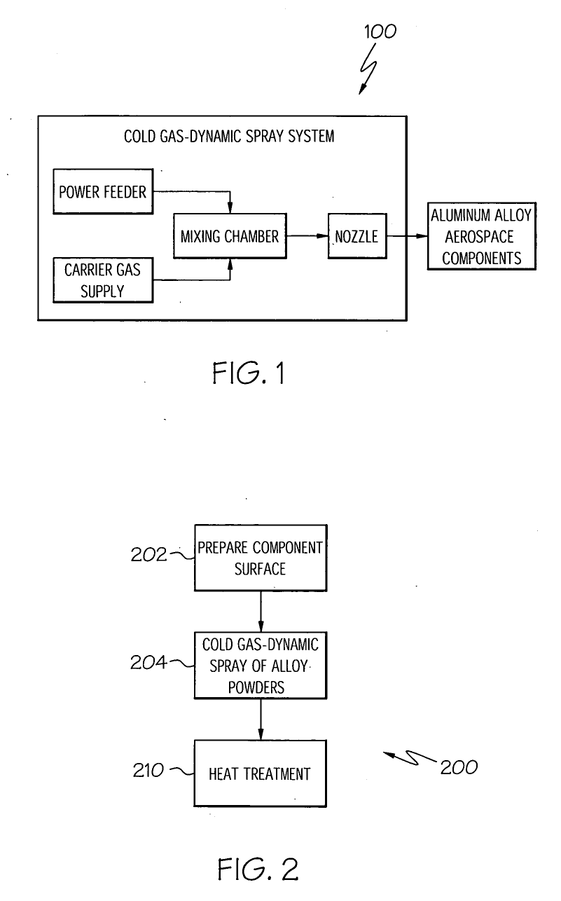

Turning now to FIG. 1, an exemplary cold gas-dynamic spray system 100 is illustrated diagrammatically. The system 100 is illustrated as a general scheme, and additional features and components can be implemented into the system 100 as necessary. The main components of the cold-gas-dynamic spray system 100 include a powder feeder for providing powder materials, a carrier gas supply for heating and accelerating powder materials at temperatures of about 300 to 400° C., a mixing chamber and a convergent-divergent nozzle. In general, the system 100 transports the metal powder mixtures with a suitable pressurized gas to the mixing chamber. The particles are accelerated by the pressurized carrier gas such as air, helium or nitrogen, through the specially designed supersonic nozzle and directed toward a targeted surface on the target being coated. Due to particle expansion in the nozzle, the particles return approximately to ambient temperature when they impact with the target surface. When the particles strike the target surface at supersonic speeds, converted kinetic energy causes plastic deformation of the particles, which in turn causes the particles to form a bond with the target surface. Thus, the cold gas-dynamic spray system 100 can bond the powder materials to a component surface and thereby strengthen and protect the component.

The cold gas dynamic spray process is referred to as a “cold gas” process because the particles are mixed and applied at a temperature that is well below their melting point. The kinetic energy of the particles on impact with the target surface, rather than particle temperature, causes the particles to plastically deform and bond with the target surface. Therefore, bonding to the component surface takes place as a solid state process with insufficient thermal energy to transition the solid powders to molten droplets.

Prior coating methods include thermal spraying to build up relatively thick and dense wear-resistant and erosion-resistant coatings. Some thermal spraying processes utilize a plasma to ionize the sprayed materials or to assist in changing the sprayed materials from solid phase to liquid or gas phase. However, thermal spraying is not a viable method for coating components made of aluminum alloys because such alloys have low melting points in comparison with the wear resistant coatings that are applied by thermal spraying. Further, aluminum tends to form brittle intermetallic phases with iron alloys, nickel alloys, titanium alloys, and others that are applied by thermal processes. Formation of such phases with iron at temperatures greater than about 460° C. can be particularly detrimental since the reaction is exothermic. In contrast, cold gas-dynamic spraying enables the sprayed alloys to bond with the aluminum or aluminum alloy component at a relatively low temperature. The particles that are sprayed using the cold gas-dynamic spraying process only incur a net gain of about 100° C. with respect to the ambient temperature. Hence, even though the mild rise in temperature due to conversion of kinetic energy combines with the effects of plastic deformation to facilitate metallurgical bonding of sprayed particles to the substrate, metallurgical reactions between the sprayed powder and the component surface are minimized. As is the case with techniques such as explosive or friction welding, oxide films that may be present on the powder or component surfaces are broken up due to the impact of the sprayed powders and bonds are effectively formed without the formation of a brittle intermetallic phase.

According to the present invention, the cold gas-dynamic spray system 100 applies high-strength metal alloys that are difficult to weld or otherwise apply to aluminum alloy component surfaces. The cold gas-dynamic spray system 100 can deposit multiple layers of differing powder mixtures, density and strengths according to the needs for the component being coated. For example, relatively thick titanium alloys may be ideal coatings for a component due to their high erosion resistance and low density. In an exemplary embodiment, the cold gas-dynamic spray system 100 deposits one or more layers of a titanium alloy to a thickness of about 0.5 mm. Since titanium alloys have low density, the titanium alloy can be sprayed onto the component at 0.5 mm or more without significantly increasing the aluminum component weight.

In another embodiment, a nickel alloy is applied to an aluminum alloy component to provide wear resistance. Nickel alloys are particularly suited as coatings for aluminum alloy components in need of sliding wear resistance due to the low coefficient of friction inherent in many such alloys. In an exemplary embodiment, the aluminum alloy is a shaft or bearing surface that is subjected to friction during use.

In another embodiment, an iron alloy is applied to an aluminum alloy component. The present invention is particularly beneficial when iron is used as a coating since conventional techniques for coating aluminum or aluminum alloys with iron are problematic. As with nickel and titanium, iron forms an intermetallic with aluminum. Iron and aluminum form a brittle intermetallic at temperatures above ˜460° C., even if joining the two metals is very carefully performed. Further, the reaction that forms the intermetallic is exothermic, and if very high temperatures are reached the brittle intermetallic disintegrates into a powdery mass. It is difficult to avoid very high reaction temperatures, and in fact the heat of the reaction between aluminum and iron is typically so high that the reaction was commonly referred to as the thermite process, and was routinely used as a means to weld rails on railways. In contrast, the cold gas-dynamic spray process of the present invention avoids formation of the intermetallic because it typically produces a maximum bulk temperature of less than 100° C. Like nickel alloys, iron alloys can provide wear resistance to surfaces, and are particularly beneficial to surfaces in need of sliding wear resistance. Many iron alloys have a low coefficient of friction, and an exemplary embodiment of the invention includes the use of the cold gas-dynamic spray system to apply an iron alloy to a shaft or bearing surface that is subjected to friction during use. Like nickel alloys, iron alloys are dense when compared to titanium alloys. Consequently, an exemplary embodiment of the invention includes cold dynamic spraying an alloy onto only selected surface areas of aluminum or aluminum alloy components that are subjected to friction during use.

In another embodiment, copper is applied to an aluminum alloy component. In addition to coatings for large aluminum components, copper coatings can be applied to electrical substrates since copper can be cold sprayed with high density and without oxidation occurring. Also, copper is an excellent heat conductor. Consequently, cold gas-dynamic sprayed copper coatings can be applied between solderable aluminum wires, at electrical junctions, or in contact with semiconductor chips.

To provide good wear resistance and/or low sliding friction hard particles, mixtures of hard and soft particles, or encapsulated hard particles (hard particles encapsulated inside softer materials) can also be sprayed onto a component surface according to an embodiment of the invention. Examples of suitable hard particles include WC, SiN, SiC, TiC, CrC, Cr, NiCr, Cr₂O₃, Al₂O₃, Yttria Stabilized Zirconia YSZ, TiB₂, hexagonal BN, and cubic BN. The hard particles are ideally smooth or even rounded and have a low coefficient of friction. Angular particles will tend to cut and wear into the mating surface, which usually is not desirable. The hard particles can be combined with or incorporated into the iron, nickel, titanium, aluminum, cobalt, and copper alloys before they are cold sprayed. Also, particles that are not particularly hard but are able to improve sliding wear by having a low coefficient of friction or a low melting point may can be combined with or incorporated into the iron, nickel, titanium, aluminum, cobalt and copper alloys either separately or in addition to the hard wear resistance particles. Examples of such soft materials and low coefficient of friction materials include lead, silver, copper oxide, barium, magnesium fluoride, copper, cobalt, rhenium, and alloys of the same. Although additives with a melting point of only a few hundred degrees would melt and even vaporize using conventional coating techniques, they can be cold gas-dynamic sprayed according to the present invention. Further, hard particles such as those discussed above may be encapsulated by soft particles such as copper and cobalt and the encapsulated forms may be combined with or incorporated into the matrix.

Although the embodiments discussed above are directed to spraying a single type of alloy such as a nickel, iron, and titanium alloy, the cold gas-dynamic spray system 100 is also useful to spray mixtures of two or more metal alloys. An exemplary embodiment, the metal powder includes selecting two or more titanium alloys, iron alloys, nickel alloys, or combinations of titanium, iron, and nickel alloys according to predetermined surface areas of an aluminum or aluminum alloy component. In yet another embodiment, the metal powder is further selected from other alloys such as aluminum alloys, copper alloys, and cobalt alloys. According to this exemplary embodiment, care is taken when selecting the alloy combination to ensure that an electric cell is not created in the metal alloy coating that would result in galvanic corrosion.

To further improve the wear resistance and erosion resistance while adding to the bulk mechanical properties for the overall aluminum or aluminum alloy component, a plurality of coating layers can be sprayed onto the component. For example, a first layer can have desirable mechanical properties and bond well with the aluminum or aluminum alloy substrate. Some examples of the first layer include a soft copper or titanium alloy. Then, a second layer can be added that has better wear resistance than the first layer. Some examples of the second layer include a NiCr alloy or a tungsten carbide in a cobalt matrix. As previously mentioned, when setting up multiple layer systems and systems with hard or soft particle additions care should be taken to avoid setting up a corrosion couple. Also, to optimize the coating compliance, the coating can be cold gas-dynamic sprayed with the hard or soft particle concentration gradient. More particularly, the hard or soft particle concentration can be modified during spraying in order to have higher hard or soft particle concentrations in particular areas and with particular thicknesses on the aluminum or aluminum alloy component.

A variety of different systems and implementations can be used to perform the cold gas-dynamic spraying process. For example, U.S. Pat. No. 5,302,414, entitled “Gas-Dynamic Spraying Method for Applying a Coating” and incorporated herein by reference, describes an apparatus designed to accelerate materials having a particle size of between 5 to about 50 microns, and to mix the particles with a process gas to provide the particles with a density of mass flow between 0.05 and 17 g/s-cm². Supersonic velocity is imparted to the gas flow, with the jet formed at high density and low temperature using a predetermined profile. The resulting gas and powder mixture is introduced into the supersonic jet to impart sufficient acceleration to ensure a particle velocity ranging between 300 and 1200 m/s. In this method, the particles are applied and deposited in the solid state, i.e., at a temperature which is considerably lower than the melting point of the powder material. The resulting coating is formed by the impact and kinetic energy of the particles which gets converted to high-speed plastic deformation, causing the particles to bond to the surface. The system typically uses gas pressures of between 5 and 20 atm, and at a temperature of up to about 400° C. As non-limiting examples, the gases can comprise air, nitrogen, helium and mixtures thereof. Again, this system is but one example of the type of system that can be adapted to cold spray the metal alloy powder materials to the target component surface according to the present invention.

Turning now to FIG. 2, an exemplary method 200 is illustrated for coating and protecting aerospace engine and vehicle components. This method includes the cold gas-dynamic spray process described above, and can also include pre- and post-spray component processing. As described above, cold gas-dynamic spray involves “solid state” processes to effect bonding and coating build-up, and does not require the application of external thermal energy for bonding to occur. However, thermal energy may be provided after cold gas-dynamic spray bonding has occurred since the thermal energy promotes formation of the desired microstructure and phase distribution for the cold gas-dynamic sprayed materials, and consequently consolidates and homogenizes the sprayed coating.

The first step 202 comprises preparing the surface on the aerospace engine or vehicle component. For example, the first step of preparing the component can involve pre-machining, degreasing and grit blasting the surface to be coated in order to remove any oxidation and dirty materials.

The next step 204 comprises performing a cold gas-dynamic spray of the metal alloy powder on the component. As described above, in cold gas-dynamic spraying, particles at a temperature below their melting temperature are accelerated and directed to a target surface on the turbine component. When the particles strike the target surface, the kinetic energy of the particles is converted into plastic deformation of the particle, causing the particle to form a strong bond with the target surface. The spraying step includes directly applying the powder to the aluminum or aluminum alloy component surface. Depending on the selected powder being sprayed and the desired protection for the aluminum or aluminum alloy component being coated, the spraying step can include covering the entire component or selected component areas.

The spraying step 204 generally brings the component to its desired dimensions, although additional machining can be performed if necessary. In an exemplary embodiment, the cold spray coating has a thickness ranging up to about 0.8 mm. The thickness is selected depending upon the component application and what type of wear the component will experience. If only a low coefficient of friction is required, a thin coating of about 0.1 mm is sufficient. For many applications, a thickness of 0.25 mm to 0.35 mm is preferred. A factor that may be primarily used to optimize the coating thickness is the effect that the coating has on the mechanical properties of the aluminum or aluminum alloy component.

The next step 210 involves performing an optional diffusion heat treatment on the component. A diffusion heat treatment can homogenize the microstructure of coating and greatly improve bonding strength between the coating and the substrate. According to an exemplary embodiment, an aerospace engine or vehicle component is heated for about 0.5 to 20 hours at a temperature between about 200 and about 450° C. to consolidate and homogenize the coating.

A separate heat treatment may also be carried out to age the aluminum substrate and the coating in order to increase their strength and toughness. Suitable aging temperatures for aluminum alloys are between about 120 and 160° C., and are performed for 1 to 20 hours. For the purpose of optimizing the coating properties, the heat treatment may be performed at higher temperatures. For example, a titanium coating may be subjected to a heat treatment of up to 600° C. The ideal temperature depends upon the alloy, the starting powder, the deposition history and the component application. Also, a two-step heat treatment may be performed. An exemplary two-step heat treatment includes a first high temperature treatment for only 1 to 3 minuets to improve bond strength, followed by a long duration, low temperature age at about 150° C. for about 15 hrs to improve both the coating strength and the aluminum substrate strength. Optimization within these ranges will provide an ideal aging treatment for both the coating and the aluminum substrate.

### EXAMPLE 1

A thick titanium coating was applied to an aluminum alloy substrate by cold gas-dynamic spraying spherical 5 to 20 micron Ti64 powder. The thick coating was built up by spraying with repeat passes.

Following the cold gas-dynamic spray process, the coating was heat treated and sectioned to determine the degree of reaction between the titanium and aluminum. Initial work on the reaction of titanium and aluminum using CVD as the coating technique indicated that a reaction between the two metals did not occur below 600° C. The first heat treatment was therefore performed for twelve hours at 6000C. The result was a reaction zone comprised of a titanium aluminide which surprisingly was 1 mm thick. It was presumed that the good bond resulting from cold spray with the removal of surface oxides characteristic of cold gas-dynamic spraying promoted diffusion of aluminum and titanium and the resultant formation of a titanium aluminide. Further, the unreacted aluminum and titanium were well bonded to the titanium aluminide zone. A hardness traverse showed that the micro hardness went from ˜120 Hv in the aluminum alloy to ˜210 Hv in the titanium aluminide to ˜330 Hv in the titanium alloy.

A second heat treatment was carried out at a much lower temperature of 400° C. for twelve hours. This time optical microscopy indicated no diffusion had occurred but there appeared to be no titanium aluminide zone, although SEM and EDX maps showed some overlap of the Ti and Al regions indicating a transition zone of around 10 microns. The transition zone can be further reduced by decreasing the time and temperature, but is acceptable for many wear and erosion resistant coatings.

The present invention thus provides an improved method for coating aluminum or aluminum alloy aerospace engine or vehicle components. The method utilizes a cold gas-dynamic spray technique to prevent wear and erosion of such components. The use of a titanium alloy, nickel alloy, and/or iron alloy coating that is relatively thick, i.e. up to about 0.5 mm, improves the mechanical properties of the component. These alloys also provide a coating with superior high temperature strength and good corrosion resistance. Spraying a thick high strength coating using the cold gas-dynamic spray technique may improve the fatigue properties of the coating/component interface rather than decrease those properties as is typical with many aluminum coating techniques such as anodizing.

While the invention has been described with reference to a preferred embodiment, it will be understood by those skilled in the art that various changes may be made and equivalents may be substituted for elements thereof without departing from the scope of the invention. For example, although the invention is primarily directed to coatings for aluminum components, the principles of the invention can be applied to other substrates such as titanium and other components. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for coating a surface of a component formed from aluminum or an alloy thereof, comprising the step of:
cold gas-dynamic spraying a powder material directly on the component surface formed from aluminum or an alloy thereof to form a coating, the powder material comprising at least one metal from the group consisting of a titanium alloy, a nickel alloy, cobalt, and a cobalt alloy.

2. The method according to claim 1, wherein the powder material comprises at least one metal from the group consisting of a titanium alloy, and a nickel alloy.

3. The method of claim 1, wherein the powder material further comprises between 5 and 45% by volume of hard, wear-resistant particles selected from the group consisting of WC, TiC, CrC, Cr, NiCr, Cr₂O₃, Al₂O₃, yttria stabilized zirconia, SiN, SiC, TiB₂, hexagonal BN, cubic BN, and combinations thereof.

4. The method of claim 1, wherein the coating of powder material further comprises between 5 to 45% by volume of soft particles with a low coefficient of friction selected from the group consisting of lead, silver, copper oxide, cobalt, rhenium, barium, magnesium fluoride, and alloys and combinations thereof.

5. The method of claim 3, wherein the coating of powder material comprises between 5 to 45% by volume of a combination of the hard, wear-resistant particles and soft particles with a low coefficient of friction selected from the group consisting of silver, copper oxide, cobalt, rhenium, barium, magnesium fluoride, and combinations thereof.

6. The method of claim 1, further comprising the step of cold gas-dynamic spraying at least one additional layer of the powder material onto the coating, the at least one additional layer having a different composition than the coating.

7. The method of claim 1, wherein the component is an aerospace engine component.

8. The method of claim 1, wherein the component is an aerospace vehicle component.

9. The method of claim 1, wherein the cold gas-dynamic spraying step is performed until the coating has a thickness ranging up to 0.8 mm.

10. The method of claim 9, wherein the cold gas-dynamic spraying step is performed until the coating has a thickness of about 0.25 to about 0.35 mm.

11. The method of claim 1, wherein the powder material comprises a titanium alloy.

12. The method of claim 1, wherein the powder material further comprises at least one metal from the group consisting of titanium, nickel, iron, an iron alloy, aluminum, an aluminum alloy, copper, and a copper alloy.

13. The method of claim 1, wherein the powder material comprises a nickel alloy.

14. The method of claim 1, wherein the component formed from aluminum or an alloy thereof is selected from the group consisting of an air starter, an impeller wheel, a valve body, a shaft, and a bearing.

15. (canceled)

16. A method for coating a surface of a component formed from aluminum or an alloy thereof, comprising the step of:
cold gas-dynamic spraying a powder material directly on the component surface formed from aluminum or an alloy thereof to form a coating, the powder material comprising at least one metal from the group consisting of a titanium alloy, a nickel alloy, cobalt, and a cobalt alloy; and
heat treating the component after the cold gas-dynamic spraying.

17. The method according to claim 16, wherein the powder material comprises at least one metal from the group consisting of a titanium alloy, and a nickel alloy.

18. The method of claim 16, wherein the powder material further comprises between 5 and 45% by volume of hard, wear-resistant particles selected from the group consisting of WC, TiC, CrC, Cr, NiCr, Cr₂O₃, Al₂O₃, yttria stabilized zirconia SiN, SiC, TiB₂, hexagonal BN, cubic BN, and combinations thereof.

19. The method of claim 16, wherein the coating of powder material further comprises between 5 to 45% by volume of soft particles with a low coefficient of friction selected from the group consisting of lead, silver, copper oxide, barium, magnesium fluoride, cobalt, rhenium, and alloys and combinations thereof.

20. The method of claim 18, wherein the coating of powder material comprises between 5 to 45% by volume of a combination of the hard, wear-resistant particles and soft particles with a low coefficient of friction selected from the group consisting of silver, copper oxide, barium, magnesium fluoride, cobalt, rhenium and combinations thereof.

21. The method of claim 16, further comprising the step of cold gas-dynamic spraying at least one additional layer of the powder material onto the coating, the at least one additional layer having a different composition than the coating.

22. The method of claim 16, wherein the component is an aerospace engine component.

23. The method of claim 16, wherein the component is an aerospace vehicle component.

24. The method of claim 16, wherein the cold gas-dynamic spraying step is performed until the coating has a thickness ranging up to 0.8 mm.

25. The method of claim 24, wherein the cold gas-dynamic spraying step is performed until the coating has a thickness of about 0.25 to about 0.35 mm.

26. The method of claim 16, wherein the powder material comprises a titanium alloy.

27. The method of claim 16, wherein the powder material further comprises at least one metal from the group consisting of titanium, nickel, iron, an iron alloy, aluminum, an aluminum alloy, copper, and a copper alloy.

28. The method of claim 16, wherein the powder material comprises a nickel alloy.

29. The method of claim 16, wherein the component formed from aluminum or an alloy thereof is selected from the group consisting of an air starter, an impeller wheel, a valve body, a shaft, and a bearing.
